(19) United States
(12) Patent Application Publication
(10) Pub. No.: US 2006/0240392 A1
(43) Pub. Date: Oct. 26, 2006

(54) Fire Engineer Traininig Simulator

(75) Inventor: Jeff Tad Clifton, Granbury, TX (US)

Correspondence Address: Mr.Jeff Tad Clifton, 5404 Corto Dr, Granbury, TX, 76049, US

(73) Assignee: Mr. Jeff Tad Clifton, Granbury, TX (US)

(21) Appl. No.: 10/908,030

(22) Filed: Apr. 26, 2005

(51) Int. Cl. G09B 19/00

(52) U.S. Cl. 434/226

(57) ABSTRACT

A mobile fire apparatus pump training simulator designed to be operated in conjunction with the fire apparatus that the student(s) will actually be using during fire suppression operations. The simulator will work with any fire apparatus in use today, whether the apparatus is manual or electronically controlled. The simulator uses plc technology with a state of the art touch screen computer controller. The basic operation begins when the instructor sets up the simulator by selecting the hose and nozzle option or one of the pre-programmed scenarios from the computer. The computer then calculates friction loss and the hose line configuration co-efficient and adjusts all of the intake control valves accordingly. The simulator uses a closed water circuit which means no water is wasted during training. The discharges of the fire apparatus are connected to the intake of the simulator and the discharge of the simulator feeds back into the pump of the fire apparatus. During this circulation of water, electronic measurements are made and the data is fed into the computer where it can be retrieved by the instructor and printed out. Multiple combinations of apparatus pump training scenarios are possible. The invention is not limited to the embodiments illustrated by the drawings or the example. Without departing form the principle of the invention, the simulator can, for instance, be used to pressure test high pressure fire hose and be used to complete pump test for apparatus.

### FIELD OF THE INVENTION

This invention relates to fire apparatus pump operations. Specifically, the invention is designed to train an apparatus operator to correctly flow water from any apparatus discharge port through a hose, through a fire nozzle and finally onto a fire.

### DESCRIPTION OF THE PRIOR ART

Historically, training personnel to operate fire apparatus involved deploying several hundred feet of fire hose, manned by several fire fighters holding nozzles and hoses. The instructor would then tell the student to start flowing water. An estimated 8,000 gallons of water is dumped out onto the ground for every 10 minutes of training time. This training was done without the benefit of knowing how the student performed. The only feedback available was watching the pressure gauge and seeing water flowing out of the nozzle.

Many variables exist when operating a fire apparatus pump. The apparatus operator must know what these variables are, how to calculate and compensate for the variables and finally how to operate the fire pump. Fire hose, by virtue of its construction, has a co-efficient of flow or “drag”. The water flows through the hose from the energy supplied to it from the fire pump. The water gives up some of its energy just getting through the hose and the rest of the energy is used to propel the water out of the fire nozzle, through the air and into the fire. With every fire hose and fire hose combination, the friction loss or “drag” changes dramatically. The fire apparatus operator knows there is a certain amount of loss and must compensate for that loss by the operation of the pump, in order to deliver the correct amount of water at the correct pressure to the firefighter with the fire nozzle.

Different apparatus pump panel simulators have been developed in the prior art. One type of tabletop pump panel simulator is electrically controlled. The students open and close the simulator valves, and the simulator uses a speaker for synthesized “noise” that the fire engine itself will make. It does not allow the user to flow any water.

Another that is very similar to the table top model with the exception that it is operated on a computer. It utilizes the space bar and up and down arrows to operate the valves. For pump operator training to have any value, the student has to flow water. This invention is the only simulator that allows the student to flow water at the actual pressures and flows required for firefighting, is able to recover all of the water used for training and allows the instructor to view real time progress of the student and provide hard copy print outs of the students performance.

### SUMMARY OF THE INVENTION

This invention utilizes a touch screen HMI (Human Machine Interface) connected to a PLC (programmable logic controller) which in turn controls the simulators' intake valves and discharge valves, retrieves data from pressure and flow transmitters, and then displays results of the students performance on the HMI.

The operation of the invention begins with attaching 50 feet of any desired diameter high pressure fire hose to one or more discharge ports of the fire apparatus and the other end of the fire hose to one or more of the simulator intake valves.

A return line is then attached to the apparatus pump suction and to the simulator pump suction control valve.

110 Volt Alternating Current is required to power the simulator either from a convenience outlet or a generator.

Once the hoses are attached to the apparatus and simulator, the simulator's recovery tank is then filled from the apparatus' booster tank until a preset level in the recovery tank is met. Once these conditions are satisfied, the instructor can select either pre programmed scenarios or hose and nozzle combinations. After the instructor has made a selection, the student will begin flowing water from the apparatus to the simulator recovery tank via the inlet piping. Once the water is delivered from the apparatus to the simulator, pressure and flow measurements are taken from the inlet piping and digitally transmitted back to the Programmable Logic Controller and then to the touch screen HMI (Human Machine Interface) and displayed in a readable format.

The initial scenario setup allows the instructor to select from either pre-programmed scenarios or hose and nozzle combinations. The pre-programmed scenarios allow the instructor to select the length of fire hose to be simulated, from 150 feet up to 350 feet of hose. Although there is only 50 feet of fire hose physically attached between the fire apparatus and the training simulator, the student must operate the apparatus to coincide with the hose selection information provided from the instructor. If the student fails to operate the apparatus pump at the required pressure, the Programmable Logic Controller records and prints out the parameters of the student's actual performance. If the instructor chooses the hose and nozzle combination from the initial selection menu, the instructor has many options to select from including the length of hose, which is between 150 feet and 350 feet, smooth bore nozzles from ⅞″ to 1⅝″ diameter or standard fog nozzles. During the actual scenario operation, the intake valves open and close upon command from the Programmable Logic Controller in varied sequences. This is to simulate firefighters opening and closing fire nozzles at a real fire. The intake valves are engineered to behave like fire nozzles and also to prevent water hammer, which is damaging to the fire apparatus' pump and valves.

The main function of the intake valves is to regulate the flow of water at a specified pressure. During scenario operations, the valves only open a percentage of full open. The degree to which the valves open is dictated by the variables selected by the instructor. When the instructor selects the variables, the Programmable Logic Controller opens and closes circuits embedded into the memory which in turn opens the intake control valves to the correct percentage of full open.

Once the water from the apparatus has traveled through the intake piping, it is collected in the recovery tank. The recovery tank maintains a specific water level at all times. This eliminates any vortex from occurring inside of the recovery tank, which in turn, eliminates air from siphoning from the recovery tank to the apparatus pump, preventing unwanted pump cavitation.

At the outlet of the recovery tank is the pump suction control valve. The function of this valve is two fold: It isolates the simulator from the apparatus during filling and water removal operations, and it serves to limit water supply during scenario operations. In several of the pre-programmed scenarios, the pump suction control valve closes to a pre-determined percentage to limit the amount of water available to the pump. This forces the student to make several adjustments to the operation of the apparatus pump in order successfully deliver water to the remaining inlet control valves, which have been selected by the instructor. The water from the recovery tank flows through the pump suction control valve and directly to the suction of the pump and is re-circulated through the entire system, thereby eliminating any wasted water.

Upon completion of each scenario, the instructor can view the performance of the student via a trend display on the HMI (Human Machine Interface) or has the option of printing out the trend display for permanent records.

### BRIEF DESCRIPTION OF THE DRAWINGS

FIG. 1-1 is the electronic control panel housing. It houses the PLC, HMI, and all associated control components.

FIG. 1-2 is the 2½″ top vent and recovery tank water level indicator and water level controller.

FIG. 1-3 is the 450 gallon capacity water recovery tank.

FIG. 1-4 is the 4″ to 6″ drafting tube. The drafting tube is partially submerged into the recovery tank and is designed to operate under a vacuum condition.

FIG. 1-5 is the inlet piping from the intake control valves to the recovery tank.

FIG. 1-6 is the pump suction control valves and associated piping.

FIG. 1-7 is the inlet piping flow data transmitters. Each transmitter is specifically calibrated for each diameter of piping.

FIG. 1-8 is the inlet control valves. These valves control the flow rate of the water from the discharge valves of the fire apparatus.

FIG. 1-9 is the inlet piping pressure transmitters. Each pressure transmitter monitors the pressure from the fire apparatus discharge valves.

FIG. 1-10 is the transport trailer and associated components.

FIG. 1-11 is the 450 gallon water recovery tank. The recovery tank can be manufactured to various sizes, according to the size of the apparatus pump, to prevent vortex and cavitation.

FIG. 2-1 is the electronic control panel housing. It houses the PLC, HMI, and all associated control components.

FIG. 2-2 is the HMI (Human Machine Interface) that is used by the instructor to select the training scenario and monitor the students progress.

FIG. 2-3 is the skid assembly. The skid assembly can be fastened to a trailer for mobility or mounted permanently to a solid surface.

FIG. 2-4 is the 2½″ top vent and recovery tank water level indicator and controller.

FIG. 2-5 is the 4″ to 6″ drafting tube. The drafting tube is partially submerged into the recovery tank and is designed to operate under a vacuum condition.

FIG. 2-6 is the pump suction control valves and associated piping.

FIG. 2-7 is the inlet piping flow data transmitters. Each transmitter is specifically calibrated for each diameter of piping.

FIG. 2-8 is the inlet control valves. These valves control the flow rate of the water from the discharge valves of the fire apparatus.

FIG. 2-9 is the inlet piping pressure transmitters. Each pressure transmitter monitors the pressure from the fire apparatus discharge valves.

FIG. 2-10 is the transport trailer and associated components.

FIG. 3-1 is the inlet connections used to connect the high pressure fire hose to the inlet piping of the simulator.

FIG. 3-2 is the inlet control valves. These valves control the flow rate of the water from the discharge valves of the fire apparatus.

FIG. 3-3 is the 4″ to 6″ drafting tube. The drafting tube is partially submerged into the recovery tank and is designed to operate under a vacuum condition.

FIG. 3-4 is the 2½″ top vent and recovery tank water level indicator and water level controller.

FIG. 3-5 is the electronic control panel housing. It houses the PLC, HMI, and all associated control components.

FIG. 3-6 is the skid assembly. The skid assembly can be fastened to a trailer for mobility or mounted permanently to a solid surface.

FIG. 3-7 is the pump suction control valves and associated piping.

FIG. 3-8 is the transport trailer and associated components.

FIG. 3-9 is the 450 gallon water recovery tank. The recovery tank can be manufactured to various sizes, according to the size of the apparatus pump, to prevent vortex and cavitation.

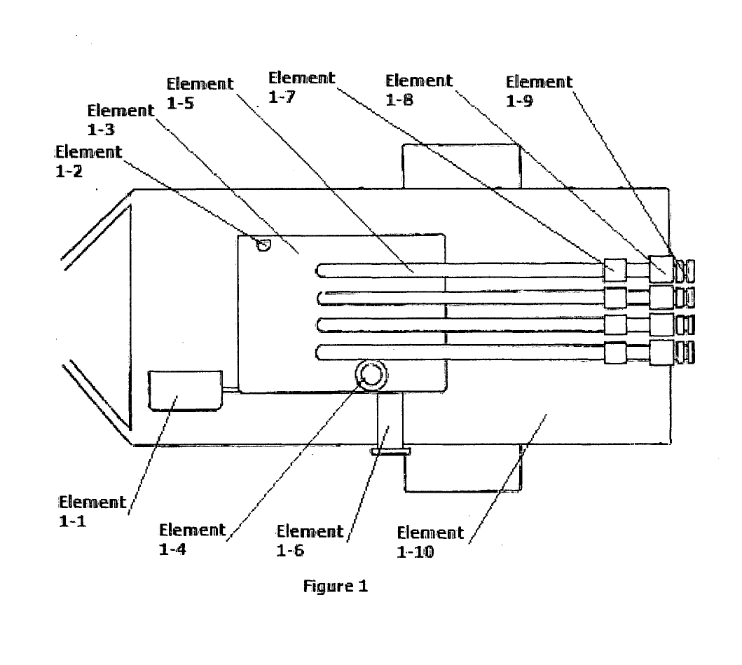

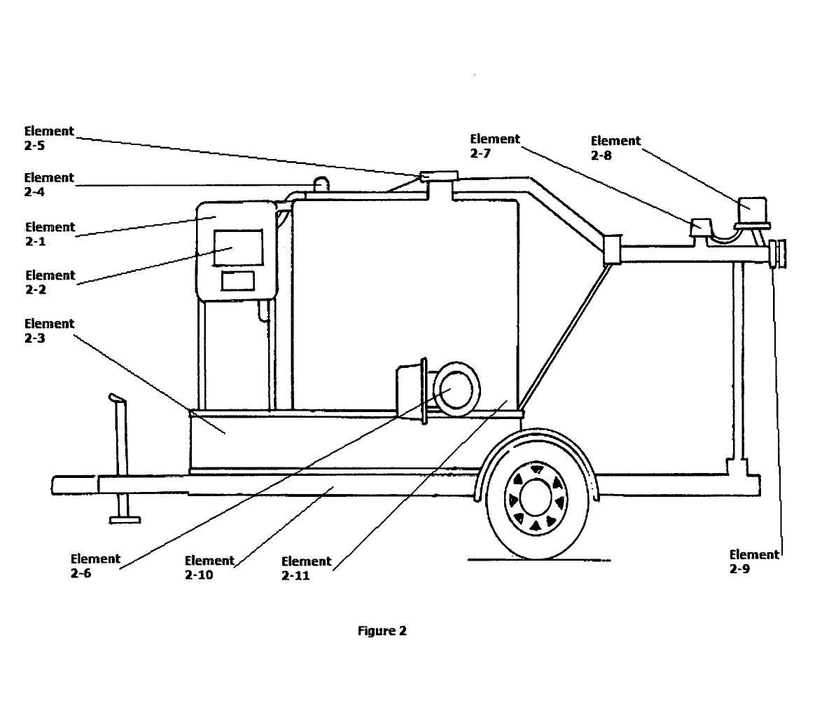

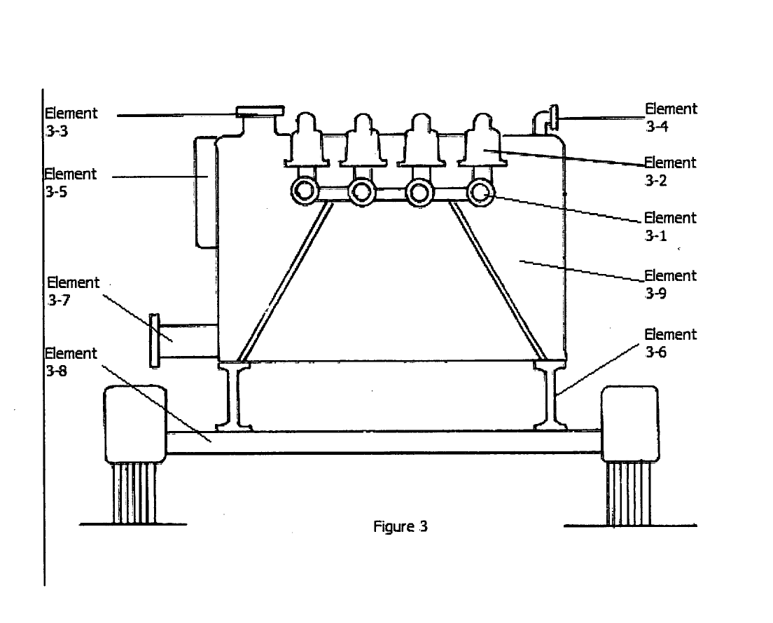

What is claimed is:

1. The invention claimed is a portable, trailer mounted or stationary simulator unit comprised of a recovery tank, computer equipment and intake and discharge valves and piping for the primary purpose of instructing fire personnel to correctly operate the pump and valve assemblies of a fire apparatus.

2. I claim that the training simulator of claim 1 whereas the recovery tank is capable of capturing all water from the discharge(s) of the apparatus pump and delivering said water back to the suction side of the apparatus pump for re-circulation thereby eliminating wasted water during apparatus pump training evolutions.

3. I claim the training simulator of claim 1 whereas the on board computer hardware and software are capable of capturing and recording parameters of velocity and pressure for all training scenarios, whether the instructor selects the pre-programmed scenarios or the hose and nozzle combination option.

4. I claim the training simulator of claim 3 whereas the on board computer hardware and software are capable of controlling specific parameters of the simulator including the intake control valves, pump suction control valve, and the recovery tank water level.

5. I claim the training simulator of claim 1 whereas the simulator can receive fire hoses from ¾″ in diameter up to 6″ and larger fire hose.

6. I claim the training simulator of claim 5 whereas the simulator only needs 50 feet of any diameter hose to function thereby eliminating the need to deploy hundreds to thousands of feet of fire hose and thereby eliminating the need to position numerous fire personnel to man fire nozzles and hoses.

7. I claim the training simulator of claim 3 whereas the simulator's on board computer is capable of displaying real time data to the instructor or anyone else wishing to view the progress of the student and has the capability to display the historical trend of the students performance during any scenario or selection made by the instructor and has the capability to print any or all historical trend data of the students performance.

8. I claim the training simulator of claim 1 whereas the simulator's pump suction control valve can be in the closed position and is capable of being operated under vacuum conditions through the use of the apparatus's priming pump and an exterior draft tube installed on the simulator's recovery tank.
